(19) United States
(12) Patent Application Publication
(10) Pub. No.: US 2026/0161356 A1
(43) Pub. Date: Jun. 11, 2026

(54) HARDWARE-BASED MIXED INSTRUCTION SET ARCHITECTURE SCHEDULER FOR MACHINE LEARNING ACCELERATOR

(71) Applicant: Amazon Technologies, Inc., Seattle, WA (US)

(72) Inventors: Subash R Patel, San Jose, CA (US); Sankalp Dayal, San Mateo, CA (US); Rahul Bakshi, San Jose, CA (US); Qiuwen Lou, Mountain View, CA (US)

(21) Appl. No.: 18/971,798

(22) Filed: Dec. 6, 2024

(51) Int. Cl. G06F 7/523; G06F 7/50

(52) U.S. Cl. CPC G06F 7/523; G06F 7/50

(57) ABSTRACT

Systems are generally described for mixed hardware instruction set architecture (ISA) scheduling. An example system includes one or more processors, a first hardware configured to execute instructions from a first ISA, and a second hardware configured to execute instructions from a second ISA. The example system may also be configured to receive a set of computer software instructions comprising a software instruction to apply a neural network operator, compile the set of computer software instructions to produce a set of hardware ISA instructions comprising a first hardware ISA instruction for the first hardware and a second hardware ISA instruction for the second hardware, send the first hardware ISA instruction to the first hardware, and send the second hardware ISA instruction to the second hardware.

### BACKGROUND

Machine learning techniques are used to form predictions, solve problems, recognize objects in image data for classification, etc. For example, machine learning techniques may be used to detect objects represented in image data, generate text, images, translate text from one human understandable language to another, etc. In various examples, machine learning models may be improved over time by retraining the models as more or different data becomes available. Accordingly, machine learning techniques are adaptive to changing conditions. Neural networks, including deep learning algorithms, are sometimes used to detect patterns in data and/or generate new data based on existing patterns.

### BRIEF DESCRIPTION OF DRAWINGS

FIG. 1 is a block diagram of an example machine learning accelerator architecture, according to various embodiments of the present disclosure.

FIG. 2 is a block diagram of an example hardware scheduler system for machine learning accelerators, in accordance with various aspects of the present disclosure.

FIG. 3 is a block diagram showing an example architecture of a network-connected device that may be used in accordance with various aspects described herein

FIG. 4 is a block diagram illustrating an example process for hardware-based mixed instruction set architecture (ISA) scheduling, in accordance with various aspects of the present disclosure.

FIG. 5 is another block diagram illustrating an example process for hardware-based mixed ISA scheduling, in accordance with various aspects of the present disclosure.

### DETAILED DESCRIPTION

In the following description, reference is made to the accompanying drawings that illustrate several examples of the various technologies described herein. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Artificial intelligence systems including various machine learning models are currently being developed and deployed for a wide variety of use cases, including generative models such as language models (e.g., large language models (LLMs)), image/video generation models (e.g., latent diffusion models), computer vision models, LLM-based agents, neural network-based classifiers, etc. Such machine learning models can be executed on general purpose processors and/or hardware accelerators using program code written with the help of programming frameworks such as TensorFlow, PyTorch, etc. The program code is converted into machine instructions by a compiler. In a neural network, the types of computations performed, and the data the computations are performed on, can be different from computations used for other things. For example, neural networks can involve repeated manipulation of large quantities of data representing tensors. The term tensor will sometimes be used herein in accord with its mathematical meaning, but will also sometimes be used herein to refer to stored data representing a tensor or a data structure storing data representing a tensor, e.g. a vector, matrix, or higher dimensional data structure. Likewise, the term scalar, vector, and matrix will sometimes be used herein in accord with their mathematical meanings but will also sometimes be used herein to refer to stored data representing scalars, vectors, and matrices or stored data representing equal or lower-dimensional mathematical objects. The term channel will sometimes be used herein to refer to a unique quality of a tensor, e.g. for a three dimensional tensor characterized as having rows, columns, and sheets (the term sheet is used here instead of the sometimes used term “channel” to avoid confusion), the term channel may refer to a row of a single sheet, a row of all sheets, a column of a single sheet, or a column of all sheets. For another example, a simple representation of RGB may use channels which correspond to color components. Mathematical operations such as convolutions may be used to learn a filter from these color channels to convert them to higher dimensional channels.

As used herein, a data structure storing weight values for a particular layer of a machine learning model may sometimes be referred to as a weight tensor. Output from a previous operation may be used with a weight tensor for a current layer (e.g., effecting matrix multiplication) to generate another tensor. An activation function may then be used with another tensor to generate an activation tensor. This activation tensor may then subsequently be used together with another weight tensor, or other intermediate operations may first be performed. For example, the weight tensor (learned during training) may be multiplied with the activation tensor (which may be output from a previous operation) to generate a new tensor (e.g., the output tensor). An activation function may be applied to the output tensor values to add non-linearity to the generated output. Weight values (and bias values) are examples of the learnable parameters of machine learning models. As used herein, weight values include both model weights and bias values.

Described herein are systems, techniques, and interfaces that may be used for hardware-based scheduling for machine learning accelerators (e.g., including neural network accelerators, or NNAs). Generally, an NNA may have a hardware instruction set architecture (ISA) that defines the computation (and data movement with external memory) for the NNA and how it performs during one or more clock cycles. The ISA may also have control instructions for internal housekeeping tasks or other instructions. New and future devices may include multiple NNA cores that may have different ISAs, owing to different hardware specifications and capabilities of each NNA core on the device. For devices with multiple NNA cores, managing all of them at the same time may be difficult. In particular, only a single NNA core could be addressed at a time, under-utilizing the total processing power of the device. Accordingly, the hardware-based scheduling techniques and systems described herein focus on the management of these compute elements that allow an abstraction of a unified machine learning accelerator that may possess varying quantities and/or architectures of MAC (multiply and accumulate) units internally. Example systems and methods disclosed herein simplify the management of these machine learning accelerator units under one common hardware interface into the software world. This simplification will allow the machine learning accelerator to interface with software by providing flexibility in generating artifacts and mapping those artifacts to the appropriate machine learning accelerator for inferencing.

Disclosed herein are systems and methods for a hardware-based scheduler that processes different ISA instructions for machine learning accelerators (e.g., including NNAs). Example systems and methods simplify the software that is used to run a machine learning model on accelerator hardware, namely compilation (process of converting a machine learning model into hardware language) and runtime (process of running the hardware language on actual machine learning accelerator hardware). Example systems and methods may allow the machine learning accelerator to consume deep learning kernels (deep learning math operations such as matrix multiplication, vector and/or matrix addition, etc.) using as few as a single hardware interface and to schedule processing of the deep learning kernels on the right downstream acceleration unit(s), thereby eliminating the need of shared hardware resources between the accelerator units (e.g., hardware semaphores, shared memory areas, and messaging queues such as hardware mailboxes and interrupts).

The various machine learning models described herein may be executed on a combination of physical and/or virtualized computing devices/resources. Physical computing resources may include, for example, hardware compute processing units (CPUs), hardware accelerators (e.g., graphics processing units (GPUs), neural processing units (NPUs), neural network accelerators (NNAs), physical memory, etc. Examples of virtualized computing resources may include virtualized CPUs, GPUs, NNAs, virtual memory, etc. Computing resources may include virtualized components executing on physical hardware. In some examples, the virtualized components and/or the physical hardware on which the virtualized components are executed may be distributed (e.g., geographically diverse). A collection of distributed compute services (e.g., of a given server instance) may be instantiated, for example, using a container orchestration framework, one or more virtual machines, physical hardware, etc. In some other examples, a given server instance may be executed on the same hardware components (and may not be distributed). Accordingly, server instances may include components that are physical and/or virtual and which may be distributed and/or co-located. A configuration for a given server instance can refer to the different hardware (whether physical or virtualized) deployed on the server instance, the software deployed on the server instance, and/or the configurations thereof.

In various examples discussed herein, some of the computing devices described herein may be provisioned with and/or may employ accelerator hardware. In some cases, machine learning accelerators (and/or general processors, depending on the implementation) may be programmed to implement an inference engine. An inference engine refers to programming a machine learning accelerator and/or general-purpose processor (or processors) to execute the various operations of a particular machine learning model. Examples of such operations may include determining dot products of two vectors, vector addition, vector multiplication, matrix multiplication, forward and backward convolutions, pooling, etc. More generally, operations may be considered as any fundamental mathematical operation on data that is represented as a scalar, vector, matrix, and/or a higher-dimensional tensor. Inference engines may be implemented using machine learning accelerator hardware and/or other specialized processors (e.g., graphical processing units, tensor processing units).

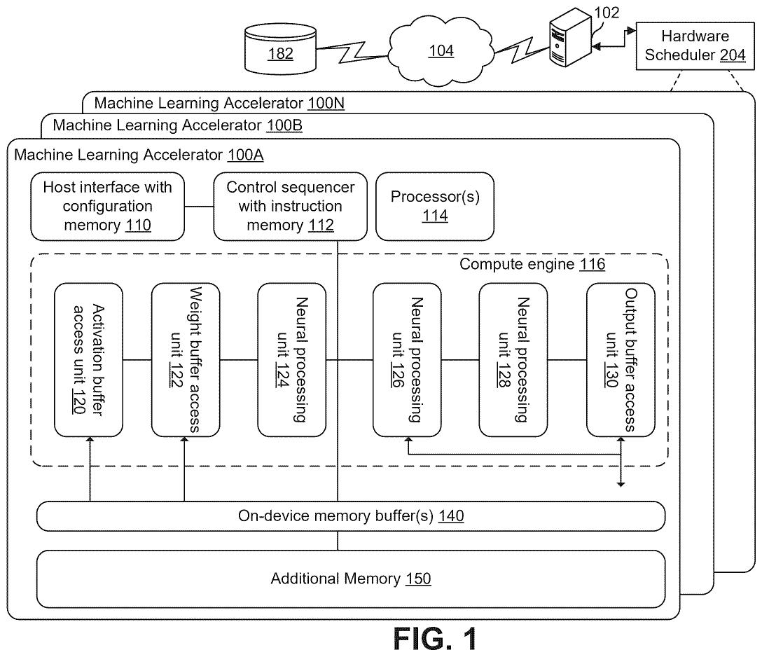

Hardware accelerators may include a class of specialized hardware accelerators designed to accelerate machine learning applications by focusing on arithmetic operations and in-memory computing capability. A neural network accelerator (NNA) architecture is an example of a machine learning accelerator hardware that has been designed to accelerate processing for neural networks. An example of an NNA is described below in reference to FIG. 1. A variety of different operations may be performed by a particular machine learning model during inference. As an example of machine learning operations (e.g., operations that may be optimized to improve performance using the various hardware and/or techniques described herein), a forward pass of a feed forward neural network is now described. It will be understood that the forward pass of the feed forward neural network is explained merely as a basic example belonging to a wide variety of general deep learning or other machine learning operations (that may have far greater complexity) that may be performed with the systems and methods disclosed herein.

The forward pass involves a series of mathematical transformations that start at the input layer, propagate through one or more hidden layers, and culminate in the output layer. Input data, usually in the form of vectors (e.g., a numerical encoding of one or more inputs token representing words or sub-words, in the context of language models), is provided to the input layer of the model. In a fully-connected example, each neuron of the input layer is connected to each neuron of the subsequent first hidden layer. For each neuron of the input layer, the value is multiplied by a respective weight (a parameter learned during training). The weight value for a given input neuron is specific to that neuron's connection with a given neuron in the first hidden layer. For a given neuron in the first hidden layer, the weighted inputs are summed together and a bias term is added. The bias term allows the activation function to be shifted to the left or right (e.g., to be more negative or more positive). This summation result may be passed through an activation function (e.g., sigmoid, a rectified linear units (ReLu) function, tanh, etc.) to introduce non-linearity into the model. The resulting value is the activation value for the first neuron in the first hidden layer. This process is repeated for each neuron in the first hidden layer. Note that the weight values connecting nodes in the input layer may be different for each distinct neuron in the first hidden layer (and similarly for the connections between subsequent hidden layers and the output layer). The activation values for the neurons at the first hidden layer (and similarly for any hidden layer and the output layer) may be stored together in a data structure referred to herein as an activation tensor. In an activation tensor, each element may correspond to a neuron and the value of that element may be the current activation value for that neuron (generated for the current input).

Machine learning techniques, such as those described herein, can be used to form predictions, solve problems, answer questions, recognize objects in image data for classification, generate images, video, and/or natural language data, etc. In various examples, machine learning models may perform better than rule-based systems and may be more adaptable as machine learning models may be improved over time by retraining the models as more and more data becomes available. Accordingly, machine learning techniques can adapt to changing conditions.

Generally, in machine learning models, such as neural networks, after initialization, annotated training data may be used to generate a differentiable cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is sometimes referred to herein as back propagation (which may be considered an application of the more general chain rule of differentiation).

As previously described, the compute cost (in terms of compute resources used) for a given inference request may vary greatly depending on the complexity of the request and the particular machine learning model being deployed. Some examples of machine learning architectures which may be deployed for inference processing are now described. It should be noted that these examples do not constitute an exhaustive list and that the inference routing and/or complexity classification techniques described herein may be used with any desired machine learning model architectures.

### Language Models

A generative LM is an artificial intelligence (AI) model that may be capable of processing and generating human-like text based on the latent information it has learned from vast amounts of training data. Language models use numerical vectors (also called embeddings) to represent words, phrases, and/or sentences to capture the semantic and syntactic properties of language. A token represents one numerical vector which could be a partial word, word, or the like. A language model is trained on a massive data set of text, where we teach it to predict the next token. There are many varieties of LMs including statistical LMs, neural LMs, and transformer-based models. LMs are used, for example, in text generation, translation, sentiment analysis, and question answering. This domain is fast advancing with human like performance for complex tasks In some cases, some LMs are referred to as “large” language models (LLMs). The term “large” refers to the size of these models in terms of the number of parameters or weights, which are the values that the model learns during training to make predictions and/or generate output such as text, synthesized speech, control instructions for control of other devices, etc. LMs may have millions, billions (or even more) parameters, which enable such models to capture complex patterns and nuances in language that, in turn, allow the models to process and generate more natural-sounding text (relative to previous approaches). LMs are typically trained on massive datasets that include a wide variety of text from various sources, enabling the LMs to “understand” grammar, context, and the relationships between words, sentences, paragraphs, etc. Examples of LMs include the generative pre-trained transformer models (e.g., GPT-3, GPT-4), Pathways Language Model (PaLM), Large Language Model Meta Artificial Intelligence (LLaMA), Claude by Antrhopic, as well as non-generative examples such as BERT (bidirectional encoder representations from Transformers), etc.

In a generative context, an LM may generate text that is responsive to the input prompt provided to the LM. LMs excel at generating natural sounding text that appears as though it has been generated by a native speaker in the relevant language. In addition to fluency, generative LMs are able to generate detailed, relevant, and largely accurate responses to input prompts in many cases due to the large amount of latent information the generative LM has learned during training. The term “prompt” may refer to plain text or structured text, and may be provided via an interface to the LM, such as an API. The prompt may generally be written in natural language, expressed, for example, as if requesting a task to be performed by the LM (e.g., “Who is the current President of the United States?”). A prompt may also be an event in a multi-modal example which uses LMs. For example, a camera frame which is sent to a vision transformer-based detector might find a person with some key scene information as tokens, which may be sent to a language model to generate text based on the tokens (as in the case of a smart doorbell camera identifying a guest outside a door). In some examples, contextual information may be provided (e.g., as part of the prompt) and/or may be retrieved (e.g., from external sources) by the LM (e.g., retrieval-augmented generation (RAG)) and used to respond to the prompt). In some examples, LMs may be instructed (e.g., using hidden prompts) as to how to use various external APIs and/or tools (e.g., online search engines and/or other software) that may, in turn, be used to perform actions responsive to user-input requests. One approach for LMs is the transformer architecture, which is described in further detail below. It should be noted, however, that transformers may be used in other machine learning contexts beyond LMs, and LMs may be built on other architectures.

### Transformer Models

Transformer models are employed in many different types of machine learning architectures, including many of the LMs previously described. The transformer is a deep learning architecture designed to handle sequential data. Unlike predecessors like RNNs, and LSTMs, transformers rely on an entirely different mechanism for sequential processing, called attention, which allows both parallel processing and captures long range dependencies in sequences. The transformer contains some key components such as the self-attention mechanism, position encoding, encode/decoder blocks, multi-head attention, feed forward networks, residual connections, and layer normalization. Transformers are powerful because of parallelization, capturing long range dependency, and easy scalability to billions of parameters. Transformer models are machine learning models that include an encoder network and a decoder network. The encoder takes an input (e.g., a “prompt”) and generates feature representations (e.g., feature vectors, feature maps, etc.) of the input. The feature representation is then fed into a decoder that may generate an output based on the encodings. In natural language processing, transformer models take sequences of words as input. A transformer may receive a sentence and/or a paragraph (or any other quantum of text) comprising a sequence of words as an input.

The encoder network of a transformer comprises a set of encoding layers that processes the input data one layer after another. Each encoder layer generates encodings (referred to herein as “tokens”). These tokens include feature representations (e.g., feature vectors and/or maps) that include information about which parts of the input data are relevant to each other. Each encoder layer passes its token output to the next encoder layer. The decoder network takes the tokens output by the encoder network and processes them using the encoded contextual information to generate an output (e.g., the aforementioned one-dimensional vector of tokens). The output data may be used to perform task-specific functions and/or generate a natural language response to the input (depending on the specific model being employed). To encode contextual information from other inputs (e.g., combined feature representation), each encoder and decoder layer of a transformer uses an attention mechanism, which for each input, weighs the relevance of every other input and draws information from the other inputs to generate the output. Each decoder layer also has an additional attention mechanism which draws information from the outputs of previous decoders, prior to the decoder layer determining information from the encodings. Both the encoder and decoder layers have a feed-forward neural network for additional processing of the outputs, and contain residual connections and layer normalization steps.

### Scaled Dot-Product Attention

The basic building blocks of the transformer are scaled dot-product attention units. When input data is passed into a transformer model, attention weights are calculated between every token simultaneously. The attention unit produces embeddings for every token in context that contain information not only about the token itself, but also a weighted combination of other relevant tokens weighted by the attention weights.

Concretely, for each attention unit the transformer model learns three weight matrices; the query weights W_{Q}, the key weights W_{K}, and the value weights W_{V}. For each token i, the input embedding xᵢ is multiplied with each of the three weight matrices to produce a query vector qᵢ=xᵢ W_{Q}, a key vector kᵢ=xᵢ W_{K}, and a value vector vᵢ=xᵢ W_{V}. Attention weights are calculated using the query and key vectors: the attention weight aᵢⱼ from token i to token j is the dot product between qᵢ and kⱼ. The attention weights are divided by the square root of the dimension of the key vectors, \sqrt{dₖ}, which stabilizes gradients during training. The attention weights are then passed through a softmax layer that normalizes the weights to sum to 1. The fact that W_{Q} and W_{K} are different matrices allows attention to be non-symmetric: if token i attends to token j, this does not necessarily mean that token j will attend to token i. The output of the attention unit for token i is the weighted sum of the value vectors of all tokens, weighted by aᵢⱼ, the attention from i to each token.

The attention calculation for all tokens can be expressed as one large matrix calculation, which is useful for training due to computational matrix operation optimizations which make matrix operations fast to compute. The matrices Q, K, and V are defined as the matrices where the ith rows are vectors qᵢ, kᵢ, and vᵢ respectively.

$$Attention ( Q , K , V ) = softmax ( \frac{{QK}^{T}}{\sqrt{{d}_{k}}} ) V$$

### Multi-Head Attention

One set of (W_{Q}, W_{K}, W_{V}) matrices is referred to herein as an attention head, and each layer in a transformer model has multiple attention heads. While one attention head attends to the tokens that are relevant to each token, with multiple attention heads the model can learn to do this for different definitions of “relevance.” The relevance encoded by transformers can be interpretable by humans. For example, in the natural language context, there are attention heads that, for every token, attend mostly to the next word, or attention heads that mainly attend from verbs to their direct objects. Since transformer models have multiple attention heads, they have the possibility of capturing many levels and types of relevance relations, from surface-level to semantic. The multiple outputs for the multi-head attention layer are concatenated to pass into the feed-forward neural network layers.

Each encoder comprises two major components: a self-attention mechanism and a feed-forward neural network. The self-attention mechanism takes in a set of input encodings from the previous encoder and weighs their relevance to each other to generate a set of output encodings. The feed-forward neural network then further processes each output encoding individually. These output encodings are finally passed to the next encoder as its input, as well as the decoders.

The first encoder takes position information and embeddings of the input data as its input, rather than encodings. The position information is used by the transformer to make use of the order of the input data. In various examples described herein, the position embedding may describe an order of a sequence of words.

Each decoder layer comprises three components: a self-attention mechanism (e.g., scaled dot product attention), an attention mechanism over the encodings, and a feed-forward neural network. The decoder functions in a similar fashion to the encoder, but an additional attention mechanism is inserted which instead draws relevant information from the encodings generated by the encoders. In a self-attention layer, the keys, values and queries come from the same place-in the case of the encoder, the output of the previous layer in the encoder. Each position in the encoder can attend to all positions in the previous layer of the encoder. In “encoder-decoder attention” layers (sometimes referred to as “cross-attention”), the queries come from the previous decoder layer, and the keys and values come from the output of the encoder. This allows every position in the decoder to attend over all positions in the input sequence. The decoder is attending to the encoder features.

The foregoing examples of machine learning processing tasks are merely examples to show the diversity (in terms of both the task and the complexity) of machine learning techniques. However, the sparse activation aware hardware and techniques described herein may be used with any machine learning tasks.

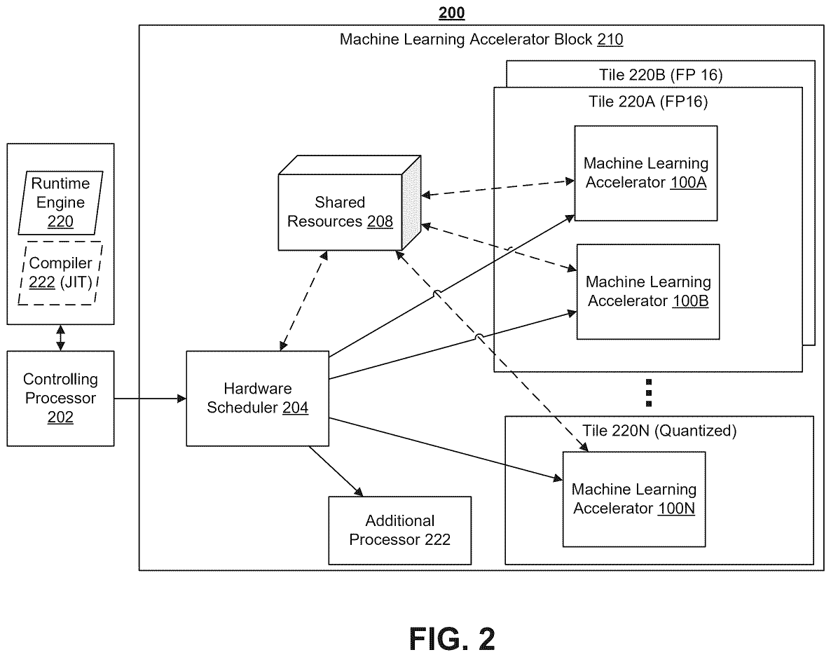

FIG. 1 is a block diagram of an example system that may be used in the context of a hardware-based mixed ISA scheduler (shown in FIG. 2), according to various embodiments of the present disclosure. In various examples, one or more computing devices 102 may include and/or be used to execute the machine learning accelerator 100A, machine learning accelerator 110B, up to machine learning accelerator 100N and/or components thereof. The hardware accelerator 204 (discussed in additional detail in connection with FIG. 2 below), which may be a component of computing device 102, may direct execution of the machine learning accelerator 110A through machine learning accelerator 110N. Additionally, the various components of the one or more computing devices 102 implementing machine learning accelerator 100A-110N may be a collection of compute services that are distributed in a cloud-based environment. The components of machine learning accelerator 100A-110N may communicate with one another and/or with remote computing devices (such as the various server instances discussed herein) via a network 104. Network 104 may be a wide area network, such as the Internet, an intranet, a local area network (LAN), and/or some combination thereof. Non-transitory computer-readable memory 182 may store instructions that, when executed by one or more processors of the one or more computing devices 102 may be effective to instantiate the various components of machine learning accelerator 100A-110N and/or perform the various techniques described herein. In various examples, the memory 182 may be one or more persistent data stores that may store the weight tensors of one or more trained machine learning models. For example, the memory 182 may store weight tensors for an LLM being executing using, at least in part, the machine learning accelerator 100A-110N.

The machine learning accelerator 100A is one example instantiation of a hardware accelerator that may be used to perform highly-parallelized computations that may be typical of machine learning inference, training, and/or testing (e.g., matrix multiplication, tensor products, etc.). However, it should be noted that other types of accelerator hardware may also be used (and/or may be used in combination with the machine learning accelerator 100) in accordance with the present disclosure. For example, graphics processing units (GPUs), tensor processing units (TPUs), field-programmable gate arrays (FPGAs), neural processing units (NPUs), application-specific integrated circuits (ASICs), inference accelerators, etc., may be used in various server instance configurations described herein.

The machine learning accelerator 100A (e.g., a neural network accelerator, GPU, etc.) comprises a host interface 110, a control sequencer 112, an optional processor 114 (e.g., one or more CPUs with any number of cores), an activation buffer access unit 120, a weight buffer access unit 122, a plurality of neural processing units (NPUs) 124, 126, and 128, an output buffer access unit 130, a set of on-device memory buffers 140, and an additional memory 150. The activation buffer access unit 120, the weight buffer access unit 122, the NPUs 124, 126, and 128, and the output buffer access unit 130 collectively form a compute engine 116. Along with the control sequencer 112, the compute engine 116 is responsible for executing instructions. Although a neural network accelerator (machine learning accelerator 100A) is shown and described in the examples of FIG. 1, the mixed ISA scheduling techniques described herein may be used with any machine learning hardware accelerator and/or with a general-purpose processor (e.g., using software).

The machine learning accelerator 100A-100N can be implemented as a standalone computing system or, as shown in FIG. 1, as part of a computing system comprising a host processor and system memory 182. The machine learning accelerator 100A depicted in FIG. 1 is merely an example and is not intended to unduly limit the scope of claimed embodiments. One of ordinary skill in the art would recognize many possible variations, alternatives, and modifications. For example, in some implementations, machine learning accelerator 100A may have more or fewer components than those shown in FIG. 1, may combine two or more components, or may have a different configuration or arrangement of components. The machine learning accelerator 100A generally executes one set of instructions at a time. This set of instructions is referred to herein as a “context.” At runtime, the machine learning accelerator 100A may sequence and dispatch, using control sequencer 112, instructions from a pre-compiled context for execution. In certain embodiments, each context comprises a set of instructions that ends with a HALT instruction. Contexts may be created by a software compiler. The instructions within a context may implement at least part of a neural network. For example, a context may correspond to a complete layer, a partial layer, or multiple layers of the neural network. In some examples, a context may correspond to a complete neural network (e.g., with instructions for an input layer, a hidden layer, and an output layer).

The host interface 110 is a communication interface to the host processor (not depicted) of the computing system. The computing system may include system memory for storing data operated on by the NNA (e.g., weights, activations, and output values corresponding to inferences). The machine learning accelerator 100A may be communicatively coupled to multiple hosts simultaneously, with any one of the hosts being able to program the machine learning accelerator 100A to execute neural network-related tasks on behalf of the host. The host interface 110 may communicate with the host processor via a standard communication protocol such as, for example, Advanced extensible Interface (AXI) protocol. Similarly, the machine learning accelerator 100A may include a separate communication interface for communicating with the system memory, e.g., to read and write data from the on-device memory buffers 140 to the system memory 182.

The control sequencer 112 may be responsible for sequencing, dispatching, and finishing execution of instructions. Some instructions may be executed entirely in the control sequencer 112, while other instructions may be dispatched to one or more of the NPUs 124, 126, and 128 for execution, possibly with execution results being returned to the control sequencer 112 for further processing. More than one instruction may be in the execution phase at any given time within the machine learning accelerator 100A. The control sequencer 112 may include an instruction memory into which instructions to be executed by the machine learning accelerator 100A are downloaded from the host processor or loaded from the system memory. In the example of FIG. 1, the host interface 110 includes a configuration memory. The configuration memory may include one or more registers that are configurable by the host processor to specify parameters relating to the context to be executed, e.g., various context dependent parameter registers (CDPRs).

In some examples, the configuration memory may include a predicate register for synchronizing execution of instructions. Instructions may be broadcast by the control sequencer 112 to each component of the compute engine 116 and the on-device memory buffers 140. Upon receipt of a broadcast instruction, a component may proceed to execute at least part of the instruction in response to determining that the component is capable of handling the instruction. For example, a first NPU 124 may receive and execute a data move instruction, but the NPUs 126 and 128 could ignore the data move instruction. Because instructions can execute concurrently in different components, it is useful to have a synchronization mechanism to handle any dependencies between instructions. The predicate register may be used to implement such a synchronization mechanism and, in some examples, may be a global register visible to internal components of the machine learning accelerator 100A and to external entities such as the host processor. Synchronization may also help to prevent conflicts in accessing the on-device memory buffers 140.

The processor 114 is an optional general-purpose processor for performing certain types of processing in parallel with processing performed by the NPUs 124, 126, and 128. For example, processor 114 may include a floating point unit or other arithmetic logic unit for performing general arithmetic operations in parallel with matrix operations performed by the NPUs 124, 126, and 128.

The activation buffer access unit 120 is configured to access one or more activation buffers in the on-device memory buffers 140. Similarly, the weight buffer access unit 122 and the output buffer access unit 130 are configured to access one or more weight buffers and one or more output buffers, respectively. The activations stored in the activation buffer(s) correspond to activations produced by one or more layers of a neural network being executed on the machine learning accelerator 100A. The weights stored in the weight buffer(s) may be synaptic weights (e.g., model parameters) associated with edges between a node of one layer and a node of another layer. Activation and weights are used for certain computations, including for instructions executed by the compute engine 116. The output buffers may store final results or intermediate results (e.g., partial sums) for access by the host processor or the system memory 182. The NPUs 124, 126, and 128 perform numerical operations using the activations and weights stored in the on-device memory buffers 140. Each NPU is configured to perform all or part of a compute instruction. Although FIG. 1 depicts the NPUs 124, 126, and 128 as block components, the NPUs 124, 126, and 128 are not necessarily identical. For example, the operations of one NPU may differ from the operations performed by another NPU.

The additional memory 150 (e.g., DRAM) is used to bidirectionally move instructions and data between the system memory and NNA on-device memories (e.g., the activation, the weight, and output buffers that form the on-device memory buffers 140). The additional memory 150 may receive data move instructions (e.g., LOAD and STORE instructions) from the control sequencer 112 when such instructions are broadcast. The data move instructions executed by additional memory 150 can execute concurrently with compute instructions executed by the control sequencer 112 or the compute engine 116.

The on-device memory buffers 140 are used to abstract the physical implementation of memories that form the activation, weight, and output buffers from NNA components (e.g., the compute engine 116) that access data in these buffers. The data in the activation, weight, and output buffers may be accessed through addressing the buffers individually, with the buffer addresses being mapped to the physical addresses of the memories where the data is stored. In some examples, the memories of the on-device memory buffers 140 may be implemented as static random-access memory (SRAM) devices. However, the on-device memory buffers 140 may be implemented using other types of memory, both volatile and non-volatile (e.g., flash memory, DRAM, resistive RAMs, and the like). The data stored in the on-device memory buffers 140 may be stored in compressed or decompressed form.

The NPUs 124, 126, and 128 may perform numerical arithmetic operations using the activations and weights stored in the on-device memory buffers 140. Each NPU may be configured to perform all or part of a compute instruction. The compute instruction may, for example, implement at least some of the computation described earlier in connection with processing by a node of a neural network, e.g., computing a weighted sum of input activations multiplied by weights, adding a bias value to the weighted sum (e.g., including using a multiply and accumulate, MAC, unit), and then applying an activation function. Other types of computations may also be performed by the NPUs 124, 126, and 128. For example, identifying the minimum and maximum values among a first set of data values represented by a first vector and a second set of data values represented by a second vector, performing an extended multiply add, subtracting two vectors, and other types of operations applicable to data from a vector or matrix may be performed.

FIG. 2 is a block diagram of an example hardware scheduler system 200 for machine learning accelerators. A controlling processor 202 may be an application processor to which the machine learning accelerator block 210 is connected (e.g., using address & data bus). The controlling processor 202 (or processors) may be any general-purpose processor for performing compilation, certain types of processing in parallel with machine learning accelerator block 210, and for issuing commands to and/or receiving results from machine learning accelerator block 210.

The hardware scheduler 204 may be an element of the machine learning accelerator block 210 that receives a mixed ISA instruction from the controlling processor 202 and schedules it on the correct accelerator (e.g., machine learning accelerator 100A through machine learning accelerator 100N). The mixed ISA instruction may contain hardware instructions that may be processed to produce instructions for more than one hardware ISA (e.g., processed by the hardware scheduler 204). The machine learning accelerator 100A, machine learning accelerator 100B, through machine learning accelerator 100N are machine learning accelerator units that may run multiply and accumulate (MAC) operations (potentially among other operations). Each accelerator may have its own ISA or share an ISA with one or more other accelerators. Accelerators may additionally include and/or have access to dedicated memories for fast access. The shared resources 208 may be available to all or some of the accelerators 206A-206N. Example resources may include memory, locking (such as hardware semaphores), mailboxes for messaging, and/or interrupts. As shown, the hardware scheduler 204 may coordinate use of shared resources 208 among the accelerators.

Machine learning accelerator units (e.g., machine learning accelerator 100A through machine learning accelerator 100N) that are used in existing devices may have different characteristics and/or capacities (e.g., with respect to the MAC units and/or SRAM capacity). If only one ISA is used across accelerators, then each accelerator may be required to be run independently, with each accelerator having its own set of individual instructions (and access to only its own individual resources). In examples disclosed herein, however, even if there are different ISAs, then there can be one hardware scheduler 204 that may decode these different ISA instructions and deploy them to right acceleration block (e.g., to the acceleration block that is configured using the specific ISA). An advantage of this approach is that accelerators may be tiled, and the software runtime engine 220 need not manage multiple accelerators individually. The software compiler 222 (e.g., running on controlling processor 202) may then generate mixed ISA for a given machine learning model, which may fully utilize any or all of the accelerator areas effectively. There may be at least two types of compilation: ahead of time and just in time (JIT). In the former case, compilation may be run on a processor (e.g., cloud desktops, laptops) and generate binary which NNAs are able to interpret. However, JIT compilation may convert a high-level instruction (also known as intermediate representation) into NNA instructions during inference.

Many existing devices use machine learning accelerators, particularly devices that operate in an edge computing context. These accelerators may have different hardware configurations based on how many MAC units are in them. In example implementations disclosed herein, these accelerators may run their own set of ISAs for running a machine learning operator. Accordingly, a machine learning operator (e.g., a math function) may be split and run concurrently on multiple accelerators to reduce the time required (latency) to compute. The hardware scheduler 204 may be configured to split and run the operator on multiple accelerators even in cases when the accelerators use different ISAs. In some examples, the hardware scheduler 204 may use load awareness. For example, a vision model may need real-time processing compared to response generation for a question or prompt. In this example, multiple models may compete for use of the NNAs, and the scheduler may allow setting a priority bit. The mixed ISA from the higher priority model may be executed before the lower priority ones.

Splitting and running ISA may be accomplished using software only, software and hardware, or with hardware only. Examples disclosed herein focuses on a hardware and software approach. Typically, the software that runs a machine learning operator on a machine learning accelerator is called a runtime engine 220. When the machine learning operator is sliced to run on multiple accelerators (with different ISA), then the runtime engine 220 may have operational overhead (e.g., forwarding the right ISA to the right hardware accelerator block). Instead, example approaches described herein use a hardware scheduler 204 which carries the complexities that would otherwise be included in software. Such a hardware scheduler 204 may reduce latency and reduce processor cycles that would otherwise be consumed by the runtime engine 220 when slicing the machine learning operator for different accelerators.

The software that may be used for converting a machine learning operator to its hardware ISA is compiler 222. Based on how and where each part of the operator will execute, the compiler 222 may generate mixed ISA instructions. The runtime engine 220 explained above may forward all these instructions into the hardware scheduler 204. The hardware scheduler 204 may forward the instructions using the ISA to the right accelerator's control block (e.g., machine learning accelerator 100A through machine learning accelerator 100N) and also may manage the accelerators' control blocks (in some accelerators, the control block has instruction FIFO and has a limited number of instructions based on the FIFO depth).

For example, the hardware scheduler 204 may forward instructions decoding an ISA instruction to the appropriate accelerator block. The ISA may define the individual instructions. The instruction may be customized for the machine learning accelerator with certain properties (e.g., a first accelerator may support floating point data, another may support integer only data, another may support quantized data, and another may support mixed precision data). When the hardware scheduler 204 receives the instruction, it may decode the instruction to understand which ISA class the instruction belongs to. Based on the information encoded into the instruction itself (e.g., by an assembler using instruction hints) and/or parsing through the instruction, the hardware scheduler 204 may know which is the appropriate choice of machine learning accelerator 110A-110N to forward the instruction. A tile or machine learning accelerators group may be a group of machine learning accelerators (including one or more of machine learning accelerator 110A-110N) which may be able to execute instructions of the same class. Machine learning accelerator groups may also contain machine learning accelerators that have different MAC configurations that support similar data type and/or precision. Furthermore, a particular machine learning accelerator may do only one kind of math operation (matrix-matrix or vector-vector, because they have shared memory to exchange data when needed). The hardware scheduler 204 may also power gate the machine learning accelerators, making them power efficient. For example, only when there is a need (based on if all machine learning accelerators in a group are already executing something) the hardware scheduler can wake up sleeping machine learning accelerators to execute the new instruction. This also means that hardware scheduler 204 may put a machine learning accelerator to sleep if it has been sitting idle for a certain duration (which is defined by the hardware implementation).

In examples implementing hardware scheduler system 200, the hardware implementation of machine learning accelerator 100A through machine learning accelerator 100N may be simplified compared to previous approaches. For example, different accelerator implementations generally have their own IP blocks (intellectual property blocks). A system-on-a-chip (SoC) design may become complex due to challenges involved around signal routing, dedicated and costly scratch pad memory (e.g., SRAM), and connecting the IP blocks over a shared peripheral bus to an application processor. Furthermore, the MAC units may consume significant power. In other examples, accelerators may be located on separate chips, which also has increased overhead costs. In contrast, the hardware scheduler system 200 may manage many of the issues that cause SoCs to become complex and guarantee that only right amount of hardware is used for the job. In examples disclosed herein, these different accelerator configurations may be treated as tiles inside the IP block (controlled by the hardware scheduler 204). These tiles may have shared memory (e.g., shared resources 208) through which they may reading and write data from system memory (e.g., internal or external memory such as DRAM, flash, etc.).

The hardware scheduler 204 may issue instructions to the accelerator tiles based on the opcode's tile info encoded into the ISA. When the ISA instruction reaches the correct tile, the control unit (which manages the compute data engine for the tile) may handle further processing. By this method, a FIFO scheduler may be implemented centrally rather than on each tile. Tiles may be groups of machine learning accelerators with certain properties in common. For example, a hardware implementer may choose to have different numbers of machine learning accelerators in each tile group: group 0 may include machine learning accelerators that can perform floating point math with full precision (fp32), group 1 may include machine learning accelerators that can use fp16 precision, group 2 may include machine learning accelerators with quantized values, and group3 may include machine learning accelerators with mixed precision (e.g., integer & float16). The example hardware implementer may give four machine learning accelerators for the quantized group/tile, but only one for fp32, two for fp16, and two for mixed precision. The distribution of machine learning accelerators to tiles may be based on power factors, allowing the silicon die to dissipate the heat generated.

Example software implementations may have additional functionalities with the approach laid out in FIG. 2. Software may be configured to share inter- and intra-operator data and create mixed ISA compiled artifacts. The simplified runtime engine 220 (with respect to previous approaches) also reduces the compute demand from the application processor, thus allowing more software applications of the machine learning model.

As depicted in FIG. 2, one or more of the machine learning accelerators 100A-100N may reside on different tiles (e.g., tile 220A, tile 220B, through tile 220N). Tiles may be groups of machine learning accelerators sharing common properties that allow them to be addressed in common by the hardware accelerator 204. For example, tiles may include machine learning accelerators capable of processing a common data type (e.g., 16-bit floating point values, 32-bit floating point values, mixed precision values, integer values, quantized data, etc.). Different tiles may also include different numbers of machine learning accelerator chips, which may be based on design considerations such as power consumption. In one example, tiles may be considered as being arranged in a three-dimensional grid, with x- and y-axes representing machine learning accelerators of different types, while the z-axis represents machine learning accelerators of the same class (e.g., single instruction multiple data, SIMD, versus multiple instruction multiple data, MIMD). In general terms, different tiles may include machine learning accelerators with different classes of hardware design.

An additional processor 222 may also be included in the machine learning accelerator block 210, and hardware scheduler 204 may be configured to address the additional processor 222 for various purposes. For example, additional instructions not normally covered by one or more of the machine learning accelerators may be effectively performed by the additional processor 222, and the hardware scheduler 204 may include additional configuration for managing and passing instructions to such hardware.

Example hardware (SoC) implementations will not be required to work on multiple IP block connections, thus reducing the time cost and potential for error. Accelerators may carry different compute capacities (due to tiling) and may allow dynamic capacity changes (e.g., by turning on/off the tiles).

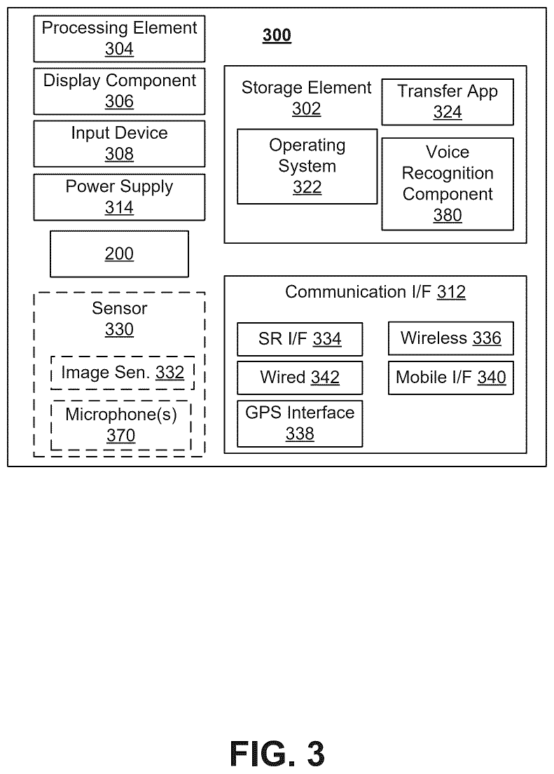

FIG. 3 is a block diagram showing an example apparatus 300, such as a device that may include the hardware scheduler system 200. In various examples, it may be advantageous to deploy the hardware scheduler system 200 in network edge devices and/or resource constrained devices (such as a device including all or some portion of the components of apparatus 300) as the hardware scheduler system 200 may lower computational requirements for model execution (e.g., for machine learning model inference).

It will be appreciated that not all devices will include all of the components of the apparatus 300 and some user devices may include additional components not shown in the apparatus 300. The apparatus 300 may include one or more processing elements 304 for executing instructions and retrieving data stored in a storage element 302. The processing element 304 may comprise at least one processor. Any suitable processor or processors may be used. For example, the processing element 304 may comprise one or more digital signal processors (DSPs). In some examples, the processing element 304 may be effective to determine a wakeword and/or to stream audio data to a speech processing system. The storage element 302 can include one or more different types of memory, data storage, or computer-readable storage media devoted to different purposes within the apparatus 300. For example, the storage element 302 may comprise flash memory, random-access memory, disk-based storage, etc. Different portions of the storage element 302, for example, may be used for program instructions for execution by the processing element 304, storage of images or other digital works, and/or a removable storage for transferring data to other devices, etc.

The storage element 302 may also store software for execution by the processing element 304. An operating system 322 may provide the user with an interface for operating the computing device and may facilitate communications and commands between applications executing on the apparatus 300 and various hardware thereof. A transfer application 324 may be configured to receive images, audio, and/or video from another device (e.g., a mobile device, image capture device, and/or display device) or from an image sensor 332 and/or microphone 370 included in the apparatus 300. In some examples, the transfer application 324 may also be configured to send the received voice requests to one or more voice recognition servers.

When implemented in some user devices, the apparatus 300 may also comprise a display component 306. The display component 306 may comprise one or more light-emitting diodes (LEDs) or other suitable display lamps. Also, in some examples, the display component 306 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 306 may be effective to display content determined provided by a skill executed by the processing element 304 and/or by another computing device. In some examples, the display component 306 and/or one or more speakers (not shown) may be effective to output an indication that unconsumed notifications (e.g., voice notifications) are pending. In some cases, there may be an indicator light effective to provide such an indication. In addition, speakers of the apparatus 300 may output the voice notification audio upon receiving a user command to consume or “read” the voice notifications.

The apparatus 300 may also include one or more input devices 308 operable to receive inputs from a user. The input devices 308 can include, for example, a push button, touch pad, touch screen, wheel, joystick, keyboard, mouse, trackball, keypad, light gun, game controller, or any other such device or element whereby a user can provide inputs to the apparatus 300. These input devices 308 may be incorporated into the apparatus 300 or operably coupled to the apparatus 300 via wired or wireless interface. In some examples, apparatus 300 may include a microphone 370 or an array of microphones for capturing sounds, such as voice requests. Voice recognition component 380 may interpret audio signals of sound captured by microphone 370. In some examples, voice recognition component 380 may listen for a “wakeword” to be received by microphone 370. Upon receipt of the wakeword, voice recognition component 380 may stream audio to a voice recognition server for analysis, such as a speech processing system. In various examples, voice recognition component 380 may stream audio to external computing devices via communication interface 312.

When the display component 306 includes a touch-sensitive display, the input devices 308 can include a touch sensor that operates in conjunction with the display component 306 to permit users to interact with the image displayed by the display component 306 using touch inputs (e.g., with a finger or stylus). The apparatus 300 may also include a power supply 314, such as a wired alternating current (AC) converter, a rechargeable battery operable to be recharged through conventional plug-in approaches, or through other approaches such as capacitive or inductive charging.

The communication interface 312 may comprise one or more wired or wireless components operable to communicate with one or more other computing devices. For example, the communication interface 312 may comprise a wireless communication module 336 configured to communicate on a network, such as a computer communication network, according to any suitable wireless protocol, such as IEEE 802.11 or another suitable wireless local area network (WLAN) protocol. A short-range interface 334 may be configured to communicate using one or more short range wireless protocols such as, for example, near field communications (NFC), Bluetooth, Bluetooth LE, etc. A mobile interface 340 may be configured to communicate utilizing a cellular or other mobile protocol. A Global Positioning System (GPS) interface 338 may be in communication with one or more earth-orbiting satellites or other suitable position-determining systems to identify a position of the apparatus 300. A wired communication module 342 may be configured to communicate according to the USB protocol or any other suitable protocol.

The apparatus 300 may also include one or more sensors 330 such as, for example, one or more position sensors, image sensors, and/or motion sensors. An image sensor 332 is shown in FIG. 3. An example of an image sensor 332 may be a camera configured to capture color information, image geometry information, and/or ambient light information.

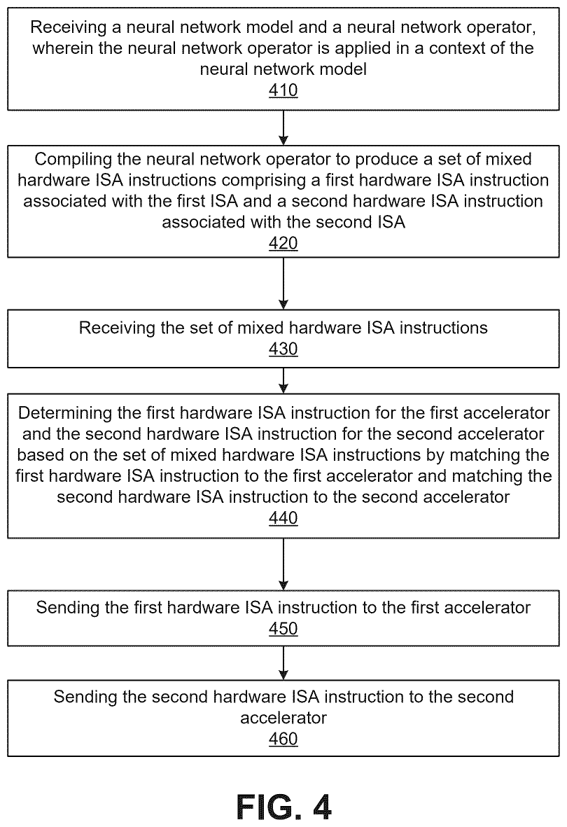

FIG. 4 is a block diagram illustrating an example process for hardware-based mixed ISA scheduling, in accordance with various aspects of the present disclosure. Example flowcharts are illustrated that contain example operations implemented by various examples described herein. The operations illustrated in FIG. 4 may, for example, be performed by a system embodied by an apparatus 300, which is shown and described in connection with FIG. 3. To perform the operations described below, the apparatus 300 may utilize one or more of storage element 302, processing element 304, input device 308, communication interface 312, sensor 330, and/or machine learning accelerator 100A-100N (including the sub-components thereof). It will be understood that user interaction with the apparatus 300 may occur directly via input device 308, or may instead be facilitated by a separate user device (e.g., using transfer application 324), and which may have similar or equivalent physical componentry facilitating such user interaction.

As shown by operation 410, apparatus 300 includes means, such as storage element 302, processing element 304, communication interface 312, and/or the like, for receiving a neural network model and a neural network operator, wherein the neural network operator is applied in a context of the neural network model. The communication interface 312 may receive any form of machine learning model, including but not limited to a neural network model, in various example implementations. The neural network operator, likewise, may be a math function that operates in the context of the machine learning model (e.g., a machine learning operator as described previously). Examples of machine learning operators may include determining dot products of two vectors, vector addition, vector multiplication, matrix multiplication, forward and backward convolutions, pooling, etc. The machine learning model may be stored as a collection of parameters (e.g., a set of weights, biases, and/or the like) using storage element 302.

As shown by operation 420, apparatus 300 includes means, such as storage element 302, processing element 304, software compiler 222, and/or the like, for compiling the neural network operator to produce a set of mixed hardware ISA instructions comprising a first hardware ISA instruction associated with the first ISA and a second hardware ISA instruction associated with the second ISA. As discussed in connection with FIG. 2 above, the software compiler 222 may convert a machine learning model operator into a hardware language capable of execution by one or more of machine learning accelerator 100A through machine learning accelerator 100N. The software compiler 222 may be configured to generate mixed ISA instructions which may be interpreted by the hardware scheduler 204 to fully utilize of the available machine learning accelerator 100A through machine learning accelerator 100N. Accordingly, the compiled mixed hardware ISA instructions may include a first instruction intended for a first ISA and a second instruction intended for a second ISA. Additionally or alternatively, the mixed hardware ISA instructions may include instructions that include an indication intended for hardware scheduler 204 that may allow the instructions to be executed by a device configured to read a particular ISA (e.g., the hardware scheduler 204 may be able to direct the instructions to one of several possible ISAs).

In some examples, the machine learning model may be received as software code, and the code may include one or more compiler hints. The compiler hints may indicate, for example, a preferred accelerator where a mathematical operation or other step specified by the code may preferentially execute. The software compiler 222 may accordingly generated the mixed ISA instructions for an appropriate accelerator as indicated by the compiler hint (provided the accelerator is capable of executing the instruction, otherwise, a warning may be returned). In some examples, the runtime engine 220 may override hints, and/or hints may be considered by the hardware scheduler 204.

As shown by operation 430, apparatus 300 includes means, such as hardware scheduler 204, and/or the like, for receiving the set of mixed hardware ISA instructions. As depicted in FIG. 2, the hardware scheduler 204 may receive the set of mixed hardware ISA instructions from controlling processor 202 (which may be compiled as described above in connection with operation 420). In some examples, the hardware scheduler 204 may physically reside on a machine learning accelerator block 210, which may be a SoC configuration. For example, a signal may be received on the machine learning accelerator block 210 (from controlling processor 202 or other processors) and routed, via signal routing and or a shared peripheral bus, to the hardware scheduler 204. The signals may comprise one or more instructions using a mixed hardware ISA instruction set, which may be interpretable by the hardware scheduler 204 and/or other components of the machine learning accelerator block 210 that are configured to receive mixed ISA signals and route ISA instructions to the appropriate on-board hardware (e.g., one or more of machine learning accelerator 100A through machine learning accelerator 100N). In some examples, hardware scheduler 204 may also reside on an accelerator card which may be plugged into a compute element in cases such as a data center. Accordingly, hardware scheduler 204 may be capable of providing scaling benefits because it is not tied to how many accelerators it can internally manage.

As shown by operation 440, apparatus 300 includes means, such as hardware scheduler 204 and/or the like for determining the first hardware ISA instruction for the first accelerator and the second hardware ISA instruction for the second accelerator based on the set of mixed hardware ISA instructions. The hardware scheduler 204 may match the first hardware ISA instruction to the first accelerator and match the second hardware ISA instruction to the second accelerator, to make the determination. In some examples, the matching may be based on identifying the appropriate ISA from the instructions and matching the ISA to the compatible accelerator from machine learning accelerator 100A to machine learning accelerator 100N.

In some examples, the hardware scheduler 204 may additionally consider load balancing. For example, the hardware scheduler 204 may receive an instruction that is executable by multiple accelerators. The hardware scheduler 204 may select the accelerator for sending the instruction based on availability or load of each accelerator. For example, the hardware scheduler 204 may record that an instruction was recently sent to machine learning accelerator 100A, and may accordingly avoid sending instructions (or de-prioritize sending instructions) to machine learning accelerator 100A for a duration of time based on an estimated time required to execute the instruction. Accordingly, the hardware scheduler 204 may determine, based on a machine state of a control unit of an accelerator, that the accelerator is ready or is not ready to receive an instruction. Subsequently, sending the instruction may be based on the determination and/or the machine state of the control unit of the accelerator. To determine the machine state of the control unit, the hardware scheduler 204 may record the machine state upon sending instructions or upon receiving a signal from the accelerator, for example. The hardware scheduler 204 may also be configured to take certain actions in the event that an instruction fails to finish on a machine learning accelerator. For example, the hardware scheduler 204 may retry the instruction on another machine learning accelerator of the same configuration a certain number of times before determining that the instruction has failed to execute. The hardware scheduler 204 may keep track of machine learning accelerators that fail to execute instruction so that time can be allowed for a reset or other corrective measures.

As shown by operation 450, apparatus 300 includes means, such as hardware scheduler 204 and/or the like for sending the first hardware ISA instruction to the first accelerator, and, as shown by operation 460, sending the second hardware ISA instruction to the second accelerator. The hardware scheduler 204 may include signal routing, and/or a shared bus to route signals to the machine learning accelerator 100A through machine learning accelerator 100N. Upon determining the destination accelerator for an instruction, the hardware scheduler 204 may route the instruction to the appropriate accelerator. In some examples, the hardware scheduler 204 may modify the instruction to convert the instruction from a mixed ISA to the compatible ISA of the destination accelerator. For example, the hardware scheduler 204 may modify formatting or perform conversions of instructions to generate an instruction using the appropriate ISA for the destination accelerator.

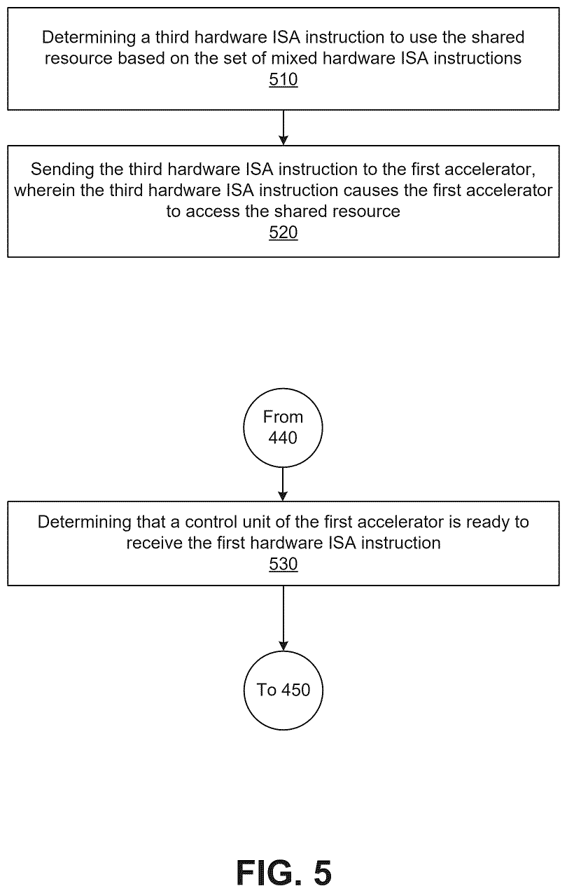

Turning now to FIG. 5, additional example operations are shown for hardware-based mixed ISA scheduling, in accordance with various aspects of the present disclosure. As shown by operation 510, apparatus 300 includes means, such as storage element 302, processing element 304, software compiler 222, and/or the like, for determining a third hardware ISA instruction to use the shared resource based on the set of mixed hardware ISA instructions. In some examples, the third hardware ISA instruction may be determined by compiling the neural network operator to produce a set of mixed hardware ISA instructions comprising the third instruction. As discussed in connection with FIG. 2 above, the software compiler 222 may convert a machine learning model operator into a hardware language capable of execution by one or more of machine learning accelerator 100A through machine learning accelerator 100N. The software compiler 222 may be configured to generate mixed ISA instructions which may be interpreted by the hardware scheduler 204 to fully utilize of the available machine learning accelerator 100A through machine learning accelerator 100N. Accordingly, the compiled mixed hardware ISA instructions may include one or more instructions that indicate that a shared resource may be used. In some examples, a compiler hint may provide the indication of using the shared resource. In some examples, the instruction may require use of a shared resource to be carried out, and thus the instruction may implicitly indicate use of the shared resource.

In some examples, the machine learning accelerator block 210 may comprise shared resources 208 coupled to one or more of machine learning accelerator 100A through machine learning accelerator 100N and hardware scheduler 204. The shared resources 208 may include memory, locking such as hardware semaphores, mailboxes for messaging, and/or interrupts.

As shown by operation 520, apparatus 300 includes means, such as hardware scheduler 204, and/or the like, for sending the third hardware ISA instruction to the first accelerator. The hardware scheduler 204 may include signal routing, and/or a shared bus to route signals to the machine learning accelerator 100A through machine learning accelerator 100N. Upon determining the destination accelerator for the instruction, the hardware scheduler 204 may route the instruction to the appropriate accelerator. In some examples, the hardware scheduler 204 may modify the instruction to convert the instruction from a mixed ISA to the compatible ISA of the destination accelerator. For example, the hardware scheduler 204 may modify formatting or perform conversions of instructions to generate an instruction using the appropriate ISA for the destination accelerator.

The third hardware ISA instruction may cause an accelerator (e.g., one of machine learning accelerator 100A through machine learning accelerator 100N, the target of the instruction) to access the shared resources 208. In some examples, the machine learning accelerator 100A through machine learning accelerator 100N may be physically capable of accessing one or more of the shared resources 208, but hardware scheduler 204 may direct the machine learning accelerator 100A through machine learning accelerator 100N to determine appropriate times for access. In some examples, the hardware scheduler 204 may maintain a local cache or other record of the machine state of each shared resources 208, including an estimated time at which the shared resources 208 may become available and/or which of the machine learning accelerator 100A through machine learning accelerator 100N may access and/or lock each of the shared resources 208.

As shown by operation 530, apparatus 300 includes means, such as hardware scheduler 204, and/or the like, for determining that a control unit of the first accelerator is ready to receive the first hardware ISA instruction. In some examples, sending the first hardware ISA instruction to the first accelerator may be based at least in part on the determining that the control unit of the first accelerator is ready to receive the first hardware ISA instruction. In some examples, the hardware scheduler 204 may additionally consider load balancing. For example, the hardware scheduler 204 may receive an instruction that is executable by multiple accelerators. The hardware scheduler 204 may select the accelerator for sending the instruction based on availability or load of each accelerator. For example, the hardware scheduler 204 may record that an instruction was recently sent to machine learning accelerator 100A, and may accordingly avoid sending instructions (or de-prioritize sending instructions) to machine learning accelerator 100A for a duration of time based on an estimated time required to execute the instruction. Accordingly, the hardware scheduler 204 may determine, based on a machine state of a control unit of an accelerator, that the accelerator is ready or is not ready to receive an instruction. Subsequently, sending the instruction may be based on the determination and/or the machine state of the control unit of the accelerator. To determine the machine state of the control unit, the hardware scheduler 204 may record the machine state upon sending instructions or upon receiving a signal from the accelerator, for example.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. An electronic device comprising:
a first neural network accelerator tile configured to select a first multiply accumulate unit, from among a first plurality of multiply accumulate units of the first neural network accelerator tile, to utilize for a first retrieved instruction based on one or more first bits thereof;
a second neural network accelerator tile configured to select a second multiply accumulate unit, from among a second plurality of multiply accumulate units of the second neural network accelerator tile, to utilize for a second retrieved instruction based on one or more second bits thereof; and
scheduler circuitry configured to select a neural network accelerator tile to utilize for a third retrieved instruction based on one or more third bits thereof.

2. The electronic device of claim 1, wherein the first neural network accelerator tile is configured for a first instruction set architecture supporting floating point operations, and the second neural network accelerator tile is configured for a second instruction set architecture supporting integer operations.

3. The electronic device of claim 1, wherein the scheduler circuitry is configured to select the neural network accelerator tile to utilize based on one or more bits indicating an instruction set architecture for an instruction.

4. The electronic device of claim 1, wherein the electronic device is a voice assistant device comprising a microphone, speaker, and wireless communication component.

5. A method comprising:
retrieving, by scheduler circuitry of a neural network accelerator device from memory of the neural network accelerator device, first data representing a first instruction;
determining, using the scheduler circuitry and based on one or more first bits of the first data, first neural network accelerator circuitry to send the first instruction to;
based on the determining of the first neural network accelerator circuitry to send the first instruction to, sending the first instruction to the first neural network accelerator circuitry by writing first instruction data to the memory of the neural network accelerator device;
retrieving, by the first neural network accelerator circuitry, the first data representing the first instruction; and
determining, using first decoder circuitry of the first neural network accelerator circuitry and based on the one or more first bits of the first data, first control instructions to send to one more multiply accumulate units of the first neural network accelerator circuitry.

6. The method of claim 5, wherein the first data was placed into the memory by a runtime engine executing using one or more central processors of an electronic device comprising the neural network accelerator device.

7. The method of claim 5, wherein the determining, using the scheduler circuitry and based on the one or more first bits of the first data, the first neural network accelerator circuitry to send the first instruction to involves determining based on one or more analog signals indicating one or more values of the one or more first bits of the first data.

8. The method of claim 5, wherein the determining, using the scheduler circuitry and based on the one or more first bits of the first data, the first neural network accelerator circuitry to send the first instruction to involves digitally determining one or more values of the one or more first bits of the first data.

9. The method of claim 5, wherein sending the first instruction to the first neural network accelerator circuitry by writing the first instruction data to the memory of the neural network accelerator device comprises writing the first data to a first memory location representing an instruction queue for a control block of the first neural network accelerator circuitry.

10. The method of claim 5, wherein sending the first instruction to the first neural network accelerator circuitry by writing the first instruction data to the memory of the neural network accelerator device comprises writing, to a first memory location representing an instruction queue for a control block of the first neural network accelerator circuitry, second data representing a pointer to a memory location of the first data.

11. The method of claim 5, wherein the method comprises sending, by writing the first instruction data to the memory of the neural network accelerator device, the first instruction to a first multiply accumulate unit of the first neural network accelerator circuitry.

12. The method of claim 5, wherein the method comprises sending, by writing the first instruction data to the memory of the neural network accelerator device, the first control instructions to a first multiply accumulate unit of the first neural network accelerator circuitry.

13. The method of claim 5, wherein the method comprises sending, by writing the first instruction data to the memory of the neural network accelerator device,
a first portion of the first control instructions to a first multiply accumulate unit of the first neural network accelerator circuitry, and
a second portion of the first control instructions to a second multiply accumulate unit of the first neural network accelerator circuitry.

14. The method of claim 5, wherein the method comprises sending, over a line, a first signal representing the first control instructions to a first multiply accumulate unit of the first neural network accelerator circuitry.

15. The method of claim 5, wherein the method comprises:
sending, over a first line, a first signal representing a first portion of the first control instructions to a first multiply accumulate unit of the first neural network accelerator circuitry; and
sending, over a second line, a second signal representing a second portion of the first control instructions to a second multiply accumulate unit of the first neural network accelerator circuitry.

16. The method of claim 5, wherein the method comprises:
retrieving, by the scheduler circuitry of the neural network accelerator device from the memory of the neural network accelerator device, second data representing a second instruction;
determining, using the scheduler circuitry and based on one or more second bits of the second data, second neural network accelerator circuitry to send the second instruction to, the second neural network accelerator circuitry being different than the first neural network accelerator circuitry;
based on the determining of the second neural network accelerator circuitry to send the second instruction to, sending the second instruction to the second neural network accelerator circuitry by writing the second data to the memory of the neural network accelerator device;
retrieving, by the second neural network accelerator circuitry, the second data representing the second instruction; and
determining, using second decoder circuitry of the second neural network accelerator circuitry and based on the one or more second bits of the second data, second control instructions to send to one more multiply accumulate units of the second neural network accelerator circuitry.

17. The method of claim 16, wherein the first instruction is an instruction of a first instruction set architecture for floating point operations and the second instruction is an instruction of a second instruction set architecture for integer operations.

18. An electronic device comprising:
first neural network accelerator circuitry comprising:
a first set of multiply accumulate units, and
a first set of one or more computer readable media storing first processor executable instructions which, when executed using circuitry of the first neural network accelerator circuitry, causes the first neural network accelerator circuitry to:
retrieve first data representing an first instruction, and
determine, based on one or more first bits of the first data representing the first instruction, one or more of the first set of multiply accumulate units to send the first data to;
second neural network accelerator circuitry comprising:
a second set of multiply accumulate units, and
a second set of one or more computer readable media storing second processor executable instructions which, when executed using circuitry of the second neural network accelerator circuitry, causes the second neural network accelerator circuitry to:
retrieve second data representing a second instruction, and
determine, based on one or more second bits of the second data representing the second instruction, one or more of the second set of multiply accumulate units to send the second data to; and
scheduler circuitry comprising:
a third set of one or more computer readable media storing third processor executable instructions which, when executed using circuitry of a third neural network accelerator circuitry, causes the third neural network accelerator circuitry to:
retrieve third data representing a third instruction,
determine, based on one or more third bits of the third data, to send the third instruction to the first neural network accelerator circuitry,
retrieve fourth data representing a fourth instruction, and
determine, based on one or more fourth bits of the fourth data, to send the fourth instruction to the second neural network accelerator circuitry.

19. The electronic device of claim 18, wherein the electronic device comprises one or more central processors and a fourth set of one or more computer readable media storing fourth processor executable instructions which, when executed using the one or more central processors, cause the electronic device to perform operations comprising:
store the third data representing the third instruction.

20. The electronic device of claim 18, wherein the electronic device is a voice assistant device comprising a microphone and speaker.
